(19) United States
(12) Patent Application Publication
(10) Pub. No.: US 2009/0120921 A1
(43) Pub. Date: May 14, 2009

(54) Method and Apparatus for Welding

(76) Inventor: Tapani Makimaa, Lahti (FI)

Correspondence Address: HARNESS, DICKEY & PIERCE, P.L.C., P.O. BOX 8910, RESTON, VA, 20195, US

(21) Appl. No.: 11/991,450

(22) PCT Filed: Sep. 4, 2006
(86) PCT No.: PCT/FI2006/000294

§ 371 Date: Nov. 17, 2008

(30) Foreign Application Priority Data
Sep. 6, 2005 (FI) 20050880

(51) Int. Cl. B23K 9/00

(52) U.S. Cl. 219/137 PS; 219/136

(57) ABSTRACT

The invention relates to a welding method and apparatus. According to the method between the welding wire and the base material an arc (4) is electrically formed, which behaves periodically (12, t2) in such a way that the duration of the period is (t2) and within the period (12) at least on average short-circuit periods (11) arise, which have an average duration (t1), and the arc voltage is controlled. According to the invention, the arc voltage is controlled at least mainly in such a way that the ratio of the average duration (t1) of the short-circuit periods (11) to the period duration (t2) is kept to a desired magnitude.

The present invention relates to a method, according to the preamble of claim 1, for welding.

The invention also relates to an apparatus for welding.

In known welding methods, such as MIG/MAG welding for example, an arc is formed between the welding wire and the base material. Depending on the behaviour of the arc, the terms short-arc, intermediate-arc, or spray-arc welding are used. In these methods, the welding is implemented either as direct-current welding, pulsed direct-current welding, or as alternating-current welding. In addition to the arc stage, a short-circuit stage occurs in welding and is either unintentional, or alternatively intentional, in which case the short-circuit stages form part of a periodic welding process.

The frequency of such a periodic process is typically 10-200 Hz. In this case, periodicity must be understood broadly, in such a way that the durations of the arc period and the short-circuit period vary statistically, however also in such a way that in each working situation the mean value remains more or less constant, even though the momentary values may deviate significantly from the mean.

One problem with MIG/MAG welding has traditionally been the setting of the welding values in such a way as to ensure a correct relationship between the wire-feed speed and the voltage. A partial solution to this problem is known, which operates satisfactorily with short-arc welding, in such a way that the voltage automatically follows the wire-feed speed. In addition, it has become apparent that the said automation covers, without selections or settings, several wire dimensions and gas alternatives. However, this procedure is limited in that its operation is restricted to the short-arc zone and even in borderline cases to only the lower end of the intermediate-arc zone.

The invention is intended to eliminate the defects of the state of the art disclosed above and for this purpose create an entirely new type of method and apparatus for short-arc welding.

The invention is based on the welding voltage being controlled in such a way that the proportion of short-circuit period relative to the total welding period remains approximately at the target value.

More specifically, the method according to the invention is characterized by what is stated in the characterizing portion of claim 1.

The apparatus according to the invention is in turn characterized by what is stated in the characterizing portion of claim 5.

Considerable advantages are gained with the aid of the invention.

The methods according to the invention also have preferred embodiments, by means of which its adaptability can be extended, in a way that will permit automatic operation over the entire power range, starting from short arc and ending at spray arc, within the limits of the power range of the equipment being used at the time.

From the welder's point of view, the adaptive control is very easy, allowing the welder to concentrate completely on the welding event itself.

In the following, the invention is examined with the aid of examples and with reference to the accompanying drawings relating to examples of applications.

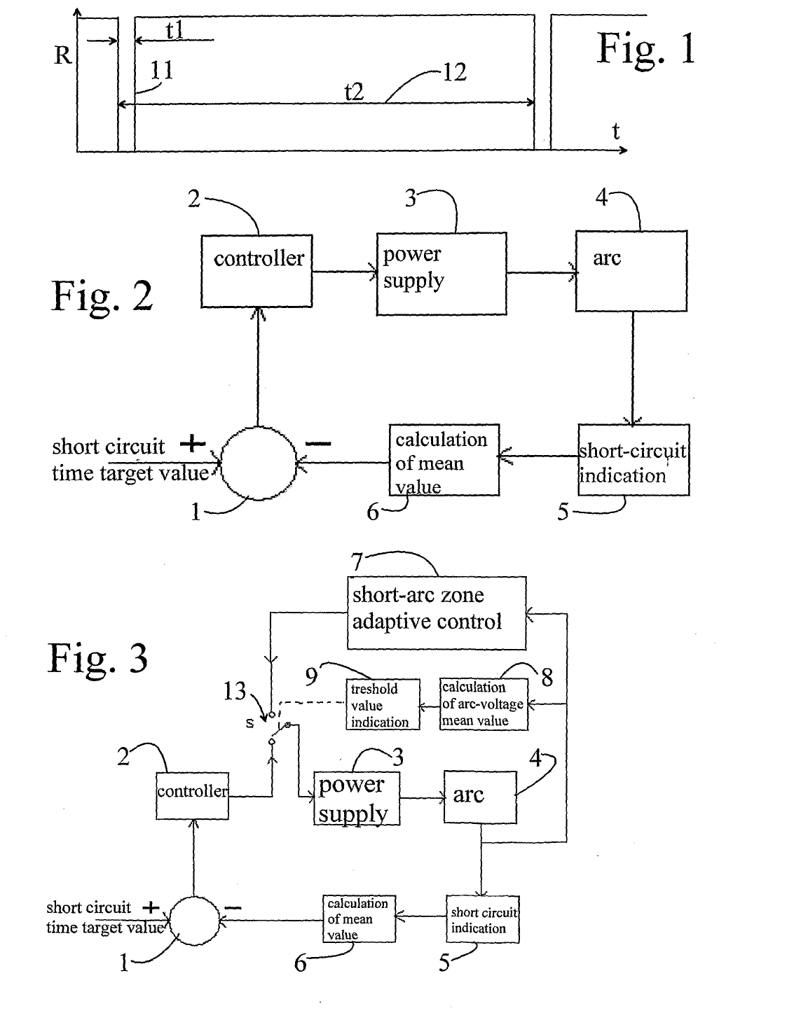

FIG. 1 shows one typical pulse shape over a single welding cycle, relating to welding to which the invention can be applied.

FIG. 2 shows a block diagram of one method according to the invention.

FIG. 3 shows a block diagram of a second method according to the invention.

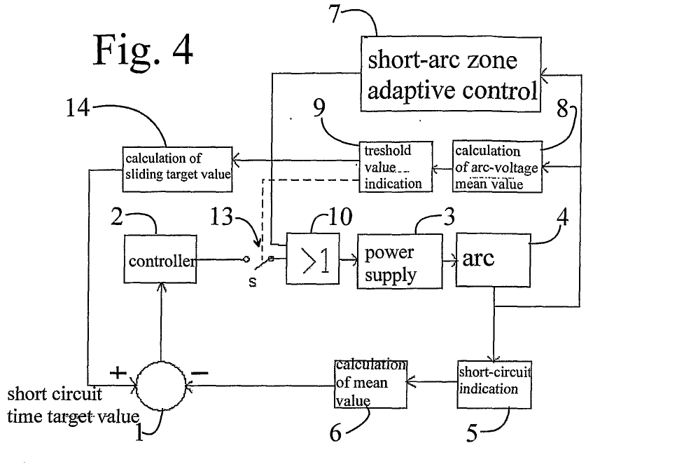

FIG. 4 shows a block diagram of a second method according to the invention.

The following terminology is used in the application in connection with the reference numbers:
1 comparator
2 controller
3 power supply
4 arc
5 short-circuit detection
6 calculation of mean value
7 short-arc zone adaptive adjustment
8 calculation of arc voltage mean value
9 threshold-value indication
10 reference block
11 short-circuit period
12 welding period
13 switch
14 calculation of sliding control value
t1 duration of short circuit
t2 duration of welding cycle

FIG. 1 shows, on a very general level, the resistance between the welding wire and the base material in the time dimension. Reference number 12 depicts the welding period and t2 its total duration. Correspondingly, reference number 11 depicts the short-circuit period and t1 its total duration. The durations t1 and t2 of the periods 11 and 12 always vary according to the arc length and other parameters. Similarly, the duration t2 of period 12 varies according to both the welding method and also during welding using the same type of welding method.

In known solutions, the adaptability of the short-arc zone is based on the measurement of the voltage during the short circuit and the use of this measurement result to adjust the power source. However, starting from the intermediate-arc zone the procedure gives too low a voltage, when the arc becomes unstable and welding becomes practically impossible.

The following terminology is used in the application in connection with the reference numbers:
1 comparator
2 controller
3 power supply
4 arc
5 short-circuit detection
6 calculation of mean value
7 short-arc zone adaptive adjustment
8 calculation of arc voltage mean value
9 threshold-value indication
10 reference block
11 short-circuit period
12 welding period
13 switch
14 calculation of sliding control value
15 duration of short circuit
16 duration of welding cycle

FIG. 1 shows, on a very general level, the resistance between the welding wire and the base material in the time dimension. Reference number 12 depicts the welding period and t2 its total duration. Correspondingly, reference number 11 depicts the short-circuit period and t1 its total duration. The durations t1 and t2 of the periods 11 and 12 always vary according to the arc length and other parameters. Similarly, the duration t2 of period 12 varies according to both the welding method and also during welding using the same type of welding method.

In known solutions, the adaptability of the short-arc zone is based on the measurement of the voltage during the short circuit and the use of this measurement result to adjust the power source. However, starting from the intermediate-arc zone the procedure gives too low a voltage, when the arc becomes unstable and welding becomes practically impossible.

The improvement according to the invention is based on the fact that when welding in the spray-arc zone, there is usually no attempt to make a pure spray arc, but instead to set the voltage in such a way as to create a situation, in which the arc is short enough for short circuits to appear now and then. In terms of welding technology, this procedure has proven to be more appropriate to the welding result. In the invention, this operating procedure is applied, in such a way that the voltage is adjusted to keep the relative short-circuit duration constant. In other words, in the case of FIG. 1 the ratio t1/t2 is kept to the desired magnitude. If, for example, the arc voltage is too low, the relative short-circuit duration t1/t2 will increase. In that case, the controller will increase the voltage until the short-circuit duration t1/t2 reaches the desired value, which is typically a few percent (this means that the arc is in a short circuit for a few percent, e.g. 5%, of the total duration t2 and the arc burns for the rest of the time, e.g. 95%, of the total time t2). Correspondingly, if the arc stretches so much that the short circuits are reduced, and in an extreme case vanish altogether, the controller reduces the voltage until the desired relative short-circuit duration is achieved. FIG. 2 shows a solution principle scheme of one possible control circuit. In terms of equipment technology, the solution can be based on traditional analog technology, or else can be implemented on the basis of processor technology, in which case the control circuit will be a suitable program implementing the principle of FIG. 2.

Thus, according to FIG. 2, the target value goes to one input of the comparator 1 and the mean value of the short-circuit duration to the other input, from a predefined period from the mean-value calculator 6. The output from the comparator 1 is zero, in which the mean value corresponds to the target value. If, on the other hand, the mean of the short-circuit duration t1/t2 is greater than the target value, the comparator 1 instructs the controller 2 to increase the arc voltage 4 with the aid of the power supply 3. The ratio of the duration t1 of the short-circuit period 11 to the duration t2 of the entire welding period 12 is measured continuously and the mean value of the results is calculated 6. Correspondingly, if the mean short-circuit duration t1/t2 is less than the target value, the comparator 1 instructs the controller 2 to reduce the arc voltage 4 with the aid of the power supply 3. The solution according to FIG. 1 will also function in the intermediate-arc zone.

In practical equipment technology it is advantageous if the adaptability functions over the entire power range of the device, starting from the short arc. This can be implemented by combining the aforementioned adaptability of the short-arc zone and the procedure shown in FIG. 1. The principle is shown in FIG. 3. Thus, the switch 13 is used to select either control according to FIG. 1, or adaptive control 7 of the short-arc zone, in parallel with implementation of calculation 8 of the mean value of the arc voltage, combined with the indication 9 of the threshold value.

The operation principle of FIG. 3 is as follows.

When operating in the short-arc zone, the mean value is typically less than 20 . . . 22 V. The switch 13 is then in the upper position and the adaptation 7 of the short-arc zone is in operation. When the mean value 8 of the arc voltage, or in some cases the wire-feed speed exceeds the set value, the fixed threshold-value 9 switch 13 turns and control of the power supply 3 is transferred to the spray-arc zone adaptive controller 2. The transfer from the short-arc zone controller 7 to the spray-arc zone controller 2 can be softened and its properties improved by making the switch-over sliding, in such a way that after the threshold the target value of the relative short-circuit duration is not set immediately to the final small value, but instead after passing the threshold the relative short-circuit duration is given a considerably large value, which is reduced as the mean value of the arc voltage or the wire-feed speed increases. In addition to this, it is preferable to keep the adaptive block 7 of the short-arc zone active, in such a way that during the longish short circuits that may appear in the transition zone, the advantageous short-arc zone adaptation is utilized. This results in the solution principle according to FIG. 4, with the aid of the additional elements 10 and 14. In this case, the device operates as follows.

When operating above the threshold value, the switch 12(S) is closed and operation is based mainly on adjustment of the relative short-circuit duration. If, in this situation, for example, a disturbance in the wire feed causes a longish short circuit to occur, the reference block 10 operating like a TAI element is used to select the signal coming from the block 7 for the control of the power supply 3, if this is greater than the signal coming from the block 2. Alternatively, it is also possible to use the sum of the signals coming from the blocks 2 and 7, because in a stable situation the signal coming from the block 7 (short-arc zone signal) is significant only in the short-arc zone and at the lower end of the intermediate-arc zone, and in addition to this the controller 2 makes sure of the correct operating point, even in a case in which some control signal comes from block 7, which according to the previous description may in no case direct the power supply to too great an output.

1. Welding method, in which method—
between the welding wire and the base material an arc is electrically formed, which behaves periodically (12, t2) in such a way that the duration of the period is (t2), and
within the period at least on average short-circuit periods arise, which have an average duration (t1), and
the input voltage for the arc is controlled,
wherein
the arc voltage is controlled at least mainly in such a way that the ratio of the duration (t1) of the short-circuit periods to the period duration (t2) is kept to a desired magnitude.

2. Method according to claim 1, wherein the arc voltage is controlled in the short-arc zone, in such a way that the arc voltage follows the wire-feed speed.

3. Method according to claim 1, wherein after the indication of a threshold value, the target value (t1/t2) of the relative short-circuit duration is not set immediately to its final low value, but instead after the threshold has been exceeded the relative short-circuit duration (t1/t2) is given a considerable higher value, which is reduced when the mean value of the arc voltage, or the wire-feed speed increases.

4. Method according to claim 3, wherein the adaptive block of the short-arc zone is kept active, in such a way that during longish short-circuits that may occur in the transitional zone, advantageous adaptation of the short-arc zone is utilized in these situations.

5. Welding apparatus, which apparatus comprises
means for forming an arc between the welding wire and the base material, which arc behaves periodically (12, t2) in such a way that the duration of the period is (t2) and
within the period at least on average short-circuit periods arise, which have an average duration (t1), and
the apparatus comprises control means for controlling the arc voltage,
wherein
the control means are such that they are able to control the arc voltage at least mainly in such a way that the ratio of the average duration (t1) of the short-circuit periods to the period duration (t2) is kept to a desired magnitude.

6. Apparatus according to claim 5, wherein it comprises means for controlling the arc voltage in the short-arc zone, in such a way that the arc voltage follows the wire-feed speed.

7. Method according to claim 5, wherein it comprises means, using which, after the indication of a threshold value, the target value (t1/t2) of the relative shortcircuit duration is not set immediately to its final low value, but instead after the threshold has been exceeded the relative short-circuit duration (t1/t2) is given a considerable higher value, which is reduced when the mean value of the arc voltage, or the wire-feed speed increases.

8. Method according to claim 7, wherein it comprises means for keeping the adaptive block of the short-arc zone active, in such a way that during longish short-circuits that may occur in the transitional zone, advantageous adaptation of the short-arc zone is utilized in these situations.
